(19) United States
(12) Patent Application Publication
(10) Pub. No.: US 2022/0019899 A1
(43) Pub. Date: Jan. 20, 2022

(54) DETECTION LEARNING DEVICE, METHOD, AND PROGRAM

(71) Applicant: NIPPON TELEGRAPH AND TELEPHONE CORPORATION, Tokyo (JP)

(72) Inventors: Kazuhiko MURASAKI, Tokyo (JP); Chihiro SAITO, Tokyo (JP); Shingo ANDO, Tokyo (JP); Atsushi SAGATA, Tokyo (JP)

(73) Assignee: NIPPON TELEGRAPH AND TELEPHONE CORPORATION, Tokyo (JP)

(21) Appl. No.: 17/312,364

(22) PCT Filed: Dec. 2, 2019
(86) PCT No.: PCT/JP2019/047006

§ 371 Date: Jun. 9, 2021

(30) Foreign Application Priority Data
Dec. 11, 2018 (JP) 2018-231895

(51) Int. Cl. G06N 3/08

(52) U.S. Cl. CPC G06N 3/084

(57) ABSTRACT

A weft-balanced detector can be trained in the vicinity of a desired TPR or PPR. A range determined by an upper limit and a lower limit of a. true positive rate or a false positive rate for defining a part of an area under a ROC curve is set so as to be narrowed at each repetition, a score function is trained so as to optimize an objective function represented using positive example data selected from ranked positive example data, negative example data, and the score function that calculates a score representing likelihood of a positive example according to the set range between the upper limit and the lower limit of the true positive rate or the false positive rate, the positive example data is ranked, the maximization learning unit and the ranking unit repeats the processing until the objective function is converged, and the region-to-be-maximized setting unit repeats setting until the range between the upper limit and the lower limit of the true positive rate or the false positive rate becomes a predetermined size.

### TECHNICAL FIELD

The present invention relates to detection learning apparatus, method, and program that classify data as a positive example or a negative example.

### BACKGROUND ART

Techniques for detecting target data from a lot of data have been devised based on machine learning approaches, and in recent years, deep learning detectors have been known to exhibit high performance on complex data.

Indicators of performance of the detector include a recall rate (or true positive rate) indicating a ratio at which target data to be detected can be correctly detected and a false positive rate indicating a ratio at which data that should not be detected is incorrectly detected. However, because there is a trade-off relationship between these rates, when training is made to increase the true positive rate (TPR), the false positive rate (FPR) disadvantageously increases. An approach of using an area under the curve (AUC) of a receiver operating characteristic (ROC) curve has been often used as an indicator for resolving such trade-off The ROC curve is a curve on a graph plotting the correspondence between the TPR and the FPR, i.e., a curve representing the correspondence between the true positive rate (TPR.) that is the probability of correctly classifying positive example data as the positive example and the false positive rate (FPR) that is the probability of incorrectly classifying negative example data as the positive example. By maximizing the AUC, which is the area formed by the ROC curve, a well-balanced detector can be trained.

### CITATION LIST

### Non Patent Literature

Non Patent Literature 1: Naonori Ueda and Akinori Fujino “Partial AUC Maximization via Nonlinear Scoring Functions.” arXiv preprint arXiv: 1806.04838 (2018).

### SUMMARY OF THE INVENTION

### Technical Problem

However, in actually utilizing the detector for a particular purpose, a detector that ensures particular performance rather than the well-balanced detector may be required. For example, given that parts produced at the factory are inspected using images to detect defective products, it is necessary to set a sufficiently high TPR so as not to pass any defective product, but for the FPR, error detection may be acceptable to some extent. Maximizing partial AUC (pAUC) has been proposed as an indicator for increasing detection performance assuming a certain TPR (Non Patent Literature 1). This is an approach that maximizes the detection performance in the corresponding TPR or FPR by maximizing a part of the area indicated by the AUC, as illustrated in FIG. 1. The pAUC maximization enables optimization in accordance with the application of the detector, but there is a problem in that overfitting tends to occur more easily to result in a local solution as the target partial region becomes narrower in the pAUC maximization.

To address such problem, according to the present invention, the detection performance in the desired TPR, or FPR is maximized by using an approach that narrows the target region in a stepwise manner to maximize the pAUC.

FIG. 1 illustrate the relationship between TPR, FPR, ROC, AUC, and pAUC.

The present invention is made in light of the foregoing circumstances, and its object is to provide detection learning apparatus, method, and program that can train a well-balanced detector in the vicinity of a desired TPR or FPR.

### Means for Solving the Problem

To achieve the above-described object, a detection learning apparatus according to a first aspect of the invention includes: a region-to-be-maximized setting unit configured to make a setting so as to narrow, at each repetition, a range determined by an upper limit and a lower limit of a true positive rate or false positive rate for defining a part of an area under a Receiver Operating Characteristic (ROC) curve on a graph representing a correspondence between the true positive rate that is probability of correctly classifying positive example data as a positive example and the false positive rate that is probability of incorrectly classifying negative example data as the positive example; a maximization learning unit configured to train a score function so as to optimize an objective function represented using positive example data selected from ranked. positive example data, negative example data, and the score function that calculates a score representing likelihood of a positive example according to the set range between the upper limit and the lower limit of the true positive rate or the false positive rate; a ranking unit configured to rank the positive example data based on the score calculated using the score function; and a determination unit configured to cause the maximization learning unit and the ranking unit to repeat the processing until the objective function is converged, and the region-to-be-maximized setting unit to repeat setting until the range between the upper limit and the lower limit of the true positive rate or the false positive rate becomes a predetermined size,

Further, in the detection learning apparatus according to the first aspect of the invention, the maximization learning unit may select positive example data included in the range between the upper limit and the lower limit when the ranking is indicated as a percentage of the total positive example data, from the ranked positive example data

A detection learning apparatus according to a second aspect of the invention includes: a region-to-be-maximized setting unit configured to make a setting so as to narrow, at each repetition, a range determined by an upper limit and a lower limit of a false positive rate for defining a part of an area under a Receiver Operating Characteristic (ROC) curve on a graph representing a correspondence between a true positive rate that is probability of correctly classifying positive example data as a positive example and the false positive rate that is probability of incorrectly classifying negative example data as the positive example; a maximization learning unit configured to train a score function so as to optimize an objective function represented using negative example data selected from ranked negative example data, positive example data, and the score function that calculates a score representing likelihood of a positive example according to the set range between the upper limit and the lower limit of the false positive rate; a ranking unit configured to rank the negative example data based on the score calculated using the score function; and a determination unit configured to cause the maximization learning unit and the ranking unit to repeat the processing until the objective function is converged, and the region-to-be-maximized setting unit to repeat setting until the range between the upper limit and the lower limit of the false positive rate becomes a predetermined size.

A detection learning method according to a third aspect of the present invention includes: at a region-to-be-maximized setting unit, making setting so as to narrow, at each repetition, a range determined by an upper limit and a lower limit of a true positive rate or false positive rate for defining a part of an area under a Receiver Operating Characteristic (ROC) curve on a graph representing a correspondence between the true positive rate that is probability of correctly classifying positive example data as a positive example and a false positive rate that is probability of incorrectly classifying negative example data. as the positive example; at a maximization learning unit, training a score function so as to optimize an objective function represented using positive example data selected from ranked positive example data, negative example data, and the score function that calculates a score representing likelihood of a positive example according to the set range between the upper limit and the lower limit of the true positive rate or the false positive rate; at a ranking unit, ranking the positive example data based on the score calculated using the score function; and at a determination unit, causing the maximization learning unit and the ranking unit to repeat the processing until the objective function is converged, and the region-to-be-maximized setting unit to repeat setting until the range between the upper limit and the lower limit of the true positive rate or the false positive rate becomes a predetermined size.

Further, in the detection learning method according to the third aspect of the invention, the maximization learning unit may select positive example data included in the range between the upper limit and the lower limit when the ranking is indicated as a. percentage of the total positive example data, from the ranked positive example data.

A detection learning method according to a fourth aspect of the present invention includes: at a region-to-be-maximized setting unit, making setting so as to narrow, at each repetition, a range determined by an upper limit and a lower limit of a false positive rate for defining a part of an area under a Receiver Operating Characteristic (ROC) curve on a graph representing a correspondence between a true positive rate that is probability of correctly classifying positive example data as a positive example and the false positive rate that is probability of incorrectly classifying negative example data as the positive example; at a maximization learning unit, training a score function so as to optimize an objective function represented using negative example data selected from ranked negative example data, positive example data, and the score function that calculates a score representing likelihood of a positive example according to the set range between the upper limit and the lower limit of the false positive rate; at a ranking unit, ranking the negative example data based on the score calculated using the score function; and at a determination unit, causing the maximization learning unit and the ranking unit to repeat the processing until the objective function is converged, and the region-to-be-maximized setting unit to repeat setting until the range between the upper limit and the lower limit of the false positive rate becomes a predetermined size.

A program according to a fifth aspect of the invention is a program that causes a computer to function as each unit of the detection learning apparatus described in the first aspect of the invention.

### Effects of the Invention

The detection learning apparatus, method, and program of the present invention can advantageously train a well-balanced detector in the vicinity of a desired TPR or FPR.

### BRIEF DESCRIPTION OF DRAWINGS

FIG. 1 is graphs illustrating an example of the relationship between TPR, FPR, ROC, AUC, and pAUC.

FIG. 2 is a block diagram illustrating a configuration of a detection learning apparatus according to an embodiment of the present invention.

FIG. 3 is a flowchart illustrating a detection learning processing routine performed by the detection learning apparatus according to the embodiment of the present invention.

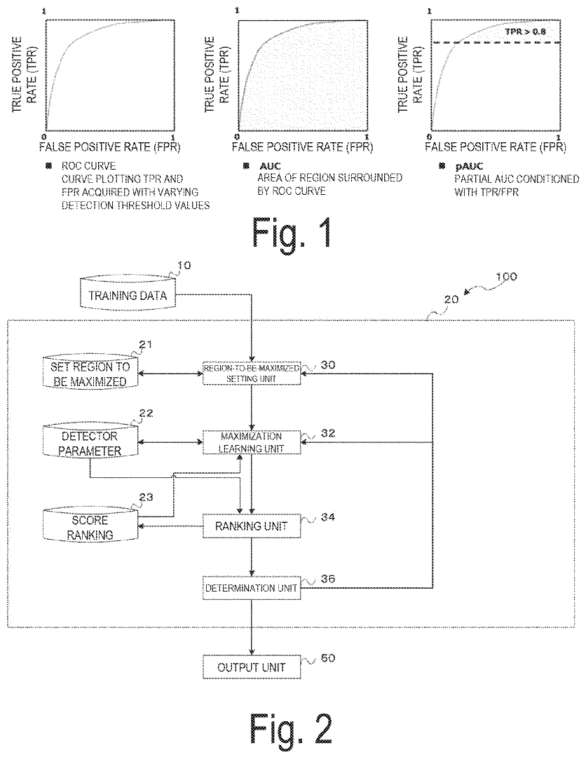

### DESCRIPTION OF EMBODIMENTS

Hereinafter, embodiments of the present invention will be described in detail with reference to the drawings.

A detector is trained by maximization of the pAUC in the vicinity of a desired TPR or FPR, In the embodiment of the present invention, a case of training the detector by the pAUC maximization in the vicinity of the TPR is described as an example. In this case, the narrow pAUC easily results in a local solution and hardly achieves high performance, while the wide pAUC cannot achieve performance specific to a desired parameter. In the embodiment of the present invention, a target region of the pAUC is initially set wide and gradually narrowed, thereby facilitating learning to achieve optimization in specific parameters.

Configuration of Detection Learning Apparatus According to Embodiment of Present Invention

Next, a configuration of a detection learning apparatus according to the embodiment of the present invention will be described. As illustrated in FIG. 2, the detection learning apparatus 100 according to the embodiment of the present invention can be configured of a computer including a CPU, a RAM, a ROM that stores a program and various data for executing a detection learning processing routine described later. As illustrated in FIG. 2, the detection learning apparatus 100 functionally includes training data 10, an operation unit 20, and an output unit 50.

The detection learning apparatus 100 receives the training data 10 with positive and negative examples.

The operation unit 20 includes a region-to-be-maximized setting unit 30, a maximization learning unit 32, a ranking unit 34, and a determination unit 36. The operation unit 20 is configured to include a region 21 to be maximized set by the region-to-be-maximized setting unit 30, a detector parameter 22 learned by the maximization learning unit 32, and score ranking 23 found by the ranking unit 34.

The region-to-be-maximized setting unit 30 determines a partial region of the AUC to be maximized. For the received training data 10, the maximization learning unit 32 trains the detector so as to maximize the pAUC for the set partial region. The ranking unit 34 executes processing of sorting the training data in the order of score according to the learned detector. The score ranking acquired by the ranking unit 34 is used in the maximization learning unit 32. The region 21 to be maximized is gradually narrowed while the determination unit 36 repeats three processes, such that the detector parameter 22 acquired at optimization in a sufficiently narrow region is output as a learning result.

Details of each processing unit will be described below.

The region-to-be-maximized setting unit 30 gradually narrows a range determined by an upper limit and a lower limit of the true positive rate for defining a part of the area under the ROC curve (region 21 to be maximized) at each repetition,

The region-to-be-maximized setting unit 30 sets a partial region of the AUC maximized based on a value of the required TPR or FPR as the region 21 to be maximized. In the present embodiment, it is assumed that the required TPR is α as an example. In this case, the FPR at the TPR of a can be minimized by maximizing the vicinity of the region where the TPR=α and however, to avoid a. local solution, learning is performed by gradually narrowing the region 21 to be maximized.

A lower limit Rₗ and an upper limit Rᵤ of the set region 21 to be maximized are expressed as a following equation (1).

[Math. 1]

Rₗ=α−δₗ⁽ⁿ⁾

Rᵤ=α+δᵤ⁽ⁿ⁾ (1)

Here, n written on the upper right of δ indicates the number of times the region-to-be-maximized setting unit 30 has made setting. Because the entire region of 0<TPR<1 is set as the target region at initial setting, it is given that δₗ⁽⁰⁾=α, δᵤ⁽⁰⁾=1−α. For the second and subsequent times, the region 21 to be maximized is changed according to a following equation (2) each time the region-to-be-maximized setting unit 30 makes setting.

[Math. 2]

δₗ⁽ⁿ⁺¹⁾=ηδₗ⁽ⁿ⁾

δᵤ⁽ⁿ⁺¹⁾=ηδᵤ⁽ⁿ⁾ (2)

Here, η is a parameter indicating am attenuation ratio of the region 21 to be maximized. η may be defined for each of l and u.

The maximization learning unit 32 trains a score function in accordance with the range between the upper limit and the lower limit of the true positive rate set by the region-to-be-maximized setting unit 30 (the region 21 to be maximized). The score function is trained so as to optimize an objective function represented using positive example data selected from ranked positive example data (the score ranking 23), negative example data, and the score function that calculates a score representing likelihood of a positive example.

The maximization learning unit 32 trains the detector parameter 22 so as to maximize the pAUC according to the set region 21 to be maximized. Here, the detector is built of a deep neural network (DNN), and learns the detector parameter 22 of the DNN based on the proper objective function by the error back-propagation method. L (Rₗ, Rᵤ) described below is used as the objective function to be minimized.

$$\begin{matrix}[ Math . 3 ] & \\ L ( {R}_{1} , {R}_{u} ) = \frac{1}{{m}_{p} ( {R}_{1} , {R}_{u} ) {m}_{n}} {\sum }_{{x}_{p} ∈ {X}_{p} ( {R}_{l} , {R}_{u} )} {\sum }_{{x}_{n}} l ( f ( {x}_{p} ) - f ( {x}_{n} ) ) & ( 3 )\end{matrix}$$

Here, f(●) indicates an output value of the DNN, and l(●) is set as a function that gives a loss to 0 or a negative value. For example, l(z)=(1−z)² proposed in Reference 1 can be used, but other functions may be used.

[Reference 1] Gao, Wei, and Zhi-Hua Zhou. “On the Consistency of AUC Pairwise Optimization” IJCAI. 2015,

xₚ and xₙ indicate the positive example data to be detected and the negative example data to be detected, respectively. In the case where total positive example data xₚ are sorted in descending order according to their score functions f(xₚ), when the ranking is expressed as the percentage of the total positive example data, Xₚ(Rₗ, Rᵤ) indicates a set of a positive example data. larger than the lower limit Rₗ and smaller than the upper limit Rᵤ. In other words, the maximization learning unit 32 selects the positive example data Xₚ(Rₗ, Rᵤ) included in the range between the upper limit and the lower limit when the ranking is expressed as the percentage of the total positive example data, from the ranked positive example data (the score ranking 23).

Similarly, mₚ(Rₗ, Rᵤ) indicates the total number of a positive example data included in Xₚ(Rₗ, Rᵤ), mₙ indicates the total number of negative example data. By minimizing the objective function in the equation (3) above, a detector that outputs a high score for positive example data and a low score for negative example data can be obtained. In particular, limiting the positive example data to some data according to the ranking of the detection scores allows for optimization comparable to the maximization of the pAUC.

The ranking unit 34 ranks the positive example data based on the scores calculated using the score functions. The ranking unit 34 uses the learned detector parameter 22 to calculate the detection scores for total positive example data, and calculates the ranking of the detection scores in descending order as the score ranking 23. Because the ranking unit 34 is located in the subsequent stage of the maximizing unit, no data on the score ranking 23 is present at initial learning. However, the region 21 to be maximized is all data enabling learning without using ranking data.

The determination unit 36 causes the maximization learning unit 32 and the ranking unit 34 to repeat the processing until the objective function in the equation (3) is converged, and the region-to-be-maximized setting unit 30 to repeat setting until the range between the upper limit and the lower limit of the true positive rate (TPR) (the region 21 to be maximized) becomes a predetermined size.

An example of detection processing performed using the detector parameter 22 acquired by the detection learning apparatus 100 according to the embodiment of the present invention will be described. In the detection processing, the score f(x) is calculated for input data x using the detector parameter 22, and detects the data as target data when the calculated score is larger than a threshold value θ. It is desirable to prepare verification data different from the training data. in the learning processing and set a threshold value at which the TPR is a in the verification data as the threshold value θ used herein.

Actions of Detection Learning Apparatus According to Embodiment of Present Invention

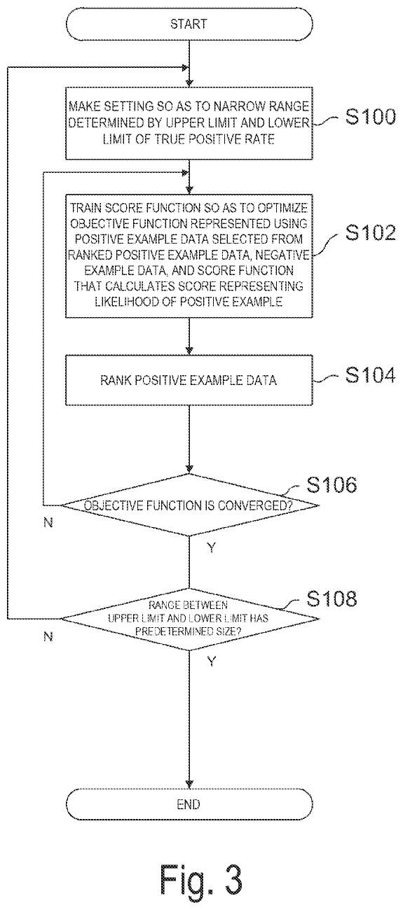

Next, actions of the detection learning apparatus 100 according to the embodiment of the present invention will be described. The detection learning apparatus 100 executes the detection learning processing routine illustrated in FIG. 3.

In Step S100, the region-to-be-maximized setting unit 30 gradually narrows the range determined by the upper limit and the lower limit of the true positive rate for defining the area under the ROC curve (the region 21 to be maximized) according to the above equation (1) at each repetition.

In Step S102, the maximization learning unit 32 trains the score function in accordance with the range between the upper limit and the lower limit of the true positive rate set in Step S100 (the region 21 to be maximized). The score function is trained so as to optimize the objective function in the above equation (3) represented using the positive example data selected from ranked positive example data (the score ranking 23). the negative example data, and the score function that calculates a score representing likelihood of a positive example.

In Step S104, the ranking unit 34 ranks the positive example data and calculates the score ranking 23 based on the scores calculated using the score functions.

In Step S106, the determination unit 36 determines whether the objective function in the above equation (3) has been converged, in accordance of a determination of convergence, proceeds to Step S108, and in accordance of a determination of non-convergence, returns to Step S102 to repeat the processing.

In Step S108, the determination unit 36 determines whether the range between the upper limit and the lower limit of the true positive rate (TPR) (the region 21 to be maximized) has been reduced to a predetermined size, in accordance with a determination that reduced to the predetermined size, terminates the processing, and in accordance with a determination that not reduced to the predetermined size, returns to Step S100 to repeat the processing

As described above, the detection learning apparatus according to the embodiment of the present invention can train a well-balanced detector in the vicinity of a desired TPR.

Note that the present invention is not limited to the above-described embodiments, and various modifications and applications may be made without departing from the gist of the present invention.

For example, in the embodiment described above, the score function is trained in the range determined by the upper limit and the lower limit of the true positive rate (TPR). However, the present invention is not limited thereto, and the score function may be trained in a range determined by the upper limit and the lower limit of the false positive rate (FPR) rather than the true positive rate. For example, in the embodiment described above, the positive example data is selected in the maximization learning unit 32, but in the case of using the false positive rate, the negative example data may be selected by replacing the positive example data with the negative example data and ranking the negative example data. In the case where total negative example data xₙ are sorted in descending order according to their score functions f(xₙ), when the ranking is expressed as the percentage of the total negative example data, a set of negative example data larger than the lower limit and smaller than the upper limit is selected.

### REFERENCE SIGNS LIST

10 Training data
20 Operation unit
21 Region to be maximized
22 Detector parameter
23 Score ranking
30 Region-to-be-maximized setting unit
32 Maximization learning unit
34 Ranking unit
36 Determination unit
50 Output unit
100 Detection learning apparatus

1. A detection learning apparatus comprising:
a region-to-be-maximized setter configured to set so as to narrow, at each repetition, a range determined by an upper limit and a lower limit of a true positive rate for defining a part of an area under a Receiver Operating Characteristic (ROC) curve on a graph representing a correspondence between the true positive rate that is probability of correctly classifying positive example data as a positive example and a false positive rate that is probability of incorrectly classifying negative example data as the positive example;
a maximization learner configured to train a score function so as to optimize an objective function represented using positive example data selected from ranked positive example data, negative example data, and the score function that calculates a score representing likelihood of a positive example according to the set range between the upper limit and the lower limit of the true positive rate;
a ranker configured to rank the positive example data based on the score calculated using the score function; and
a determiner configured to cause the maximization learner and the rank to repeat the processing until the objective function is converged, and the region-to-be-maximized setter to repeat setting until the range between the upper limit and the lower limit of the true positive rate becomes a predetermined size.

2. The detection learning apparatus according to claim 1, wherein the maximization learner selects positive example data included in the range between the upper limit and the lower limit when the ranking is indicated as a percentage of the total positive example data, from the ranked positive example data.

3. The detection learning apparatus according to claim 1, the apparatus further comprising:
the region-to-be-maximized setter configured to set so as to narrow, at each repetition, the range determined by an upper limit and a lower limit of a false positive rate for defining a part of an area under a Receiver Operating Characteristic (ROC) curve on the graph representing a correspondence between the true positive rate that is probability of correctly classifying positive example data as the positive example and the false positive rate that is probability of incorrectly classifying negative example data as the positive example;
the maximization learner configured to train the score function so as to optimize an objective function represented using negative example data selected from ranked negative example data, positive example data, and the score function that calculates a score representing likelihood of a positive example according to the set range between the upper limit and the lower limit of the false positive rate;
the ranker configured to rank the negative example data based on the score calculated using the score function.

4. A detection learning method comprising:
setting, by a region-to-be-maximized setter so as to narrow, at each repetition, a range determined by an upper limit and a lower limit of a true positive rate for defining a part of an area under a Receiver Operating Characteristic (ROC) curve on a graph representing a correspondence between the true positive rate that is probability of correctly classifying positive example data as a positive example and a false positive rate that is probability of incorrectly classifying negative example data as the positive example;
training, by a maximization learner, a score function so as to optimize an objective function represented using positive example data selected from ranked positive example data, negative example data, and the score function that calculates a score representing likelihood of a positive example according to the set range between the upper limit and the lower limit of the true positive rate;
ranking, by a ranker, the positive example data based on the score calculated using the score function; and
causing, by a determiner, causing the maximization learner and the ranker to repeat the processing until the objective function is converged, and the region-to-be-maximized setter to repeat setting until the range between the upper limit and the lower limit of the true positive rate becomes a predetermined size.

5. The detection learning method according to claim 4, wherein the maximization learner selects positive example data included in the range between the upper limit and the lower limit when the ranking is indicated as a percentage of the total positive example data, from the ranked positive example data.

6. A detection learning method comprising:
setting, by a region-to-be-maximized setter, so as to narrow, at each repetition, a range determined by an upper limit and a lower limit of a false positive rate for defining a part of an area under a Receiver Operating Characteristic (ROC) curve on a graph representing a correspondence between a true positive rate that is probability of correctly classifying positive example data as a positive example and the false positive rate that is probability of incorrectly classifying negative example data as the positive example;
training, by a maximization learner, a score function so as to optimize an objective function represented using negative example data selected from ranked negative example data, positive example data, and the score function that calculates a score representing likelihood of a positive example according to the set range between the upper limit and the lower limit of the false positive rate;
ranking, by a ranker, the negative example data based on the score calculated using the score function; and
causing, by a determiner, the maximization learner and the ranker to repeat the processing until the objective function is converged, and the region-to-be-maximized setter to repeat setting until the range between the upper limit and the lower limit of the false positive rate becomes a predetermined size.

7. (canceled)

8. The detection learning apparatus according to claim 1, wherein the maximization learner learns one or more detector parameters of a deep neural network based on the objective function.

9. The detection learning apparatus according to claim 1, wherein the objective function is based on an error back-propagation method.

10. The detection learning apparatus according to claim 1, wherein the positive example data include a plurality of images of parts for inspecting defective products in production.

11. The detection learning apparatus according to claim 3, wherein the maximization learner selects negative example data included in the range between the upper limit and the lower limit when the ranking is indicated as a percentage of the total negative example data, from the ranked negative example data.

12. The detection learning apparatus according to claim 3, wherein the maximization learner learns one or more detector parameters of a deep neural network based on the objective function.

13. The detection learning apparatus according to claim 3, wherein the objective function is based on an error back-propagation method.

14. The detection learning apparatus according to claim 3, wherein the negative example data include a plurality of images of defective parts for inspecting defective products in production.

15. The detection learning method according to claim 4, wherein the maximization learner learns one or more detector parameters of a deep neural network based on the objective function.

16. The detection learning method according to claim 4, wherein the objective function is based on an error back-propagation method.

17. The detection learning method according to claim 4, wherein the positive example data include a plurality of images of parts for inspecting defective products in production.

18. The detection learning method according to claim 6, wherein the maximization learner selects negative example data included in the range between the upper limit and the lower limit when the ranking is indicated as a percentage of the total negative example data, from the ranked negative example data.

19. The detection learning method according to claim 6, wherein the maximization learner learns one or more detector parameters of a deep neural network based on the objective function.

20. The detection learning method according to claim 6, wherein the objective function is based on an error back-propagation method.

21. The detection learning method according to claim 6, wherein the negative example data include a plurality of images of defective parts for inspecting defective products in production.
